(19) United States
(12) Patent Application Publication
(10) Pub. No.: US 2006/0021996 A1
(43) Pub. Date: Feb. 2, 2006

(54) Multi-chambered drink bottle

(76) Inventors: L. James Scott III, Atlanta, GA (US); Inocencio Martinez, Kennesaw, GA (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/903,181

(22) Filed: Jul. 30, 2004

(51) Int. Cl. B67D 5/60; B65D 25/04; A47G 19/22

(52) U.S. Cl. 222/145.5; 220/507; 215/387; 215/6; 220/717

(57) ABSTRACT

A drink bottle for separately containing and delivering to the mouth of the user two or more liquids is disclosed. Some embodiments comprise a mixing chamber wherein the liquids are mixed prior to being discharged through an orifice. Deformable containers permit the liquids to be delivered or forced into the mixing chamber by squeezing the sides of the bottle. In certain embodiments, check valves are provided to prevent the flow of liquid from the mixing chamber into the separate liquid containers. In one embodiment, the liquids are delivered through tubes arranged in a spiral configuration for novelty effect.

### BACKGROUND OF THE INVENTION

1. Field of the Invention

The invention relates to drinking bottles. More particularly, it relates to pre-filled, multi-chambered drink bottles.

2. Description of the Related Art

Squeezable drink bottles for water, fruit juices, sport drinks, non-carbonated soft drinks and the like are well-known in the pre-packaged beverage industry. The containers of the prior art, however, dispense the packaged beverage from a single chamber and no means are provided for mixing the contents of multiple chambers during the dispensing process.

### SUMMARY OF THE INVENTION

A dual-chambered, squeezable, drink bottle has a mixing compartment which receives fluid from each of two chambers which may contain different beverages or different components of a beverage. The two components (or two beverages) combine in the mixing compartment prior to discharging from a single orifice. A particularly pleasing effect is provided when brightly-colored beverages are used. In addition to its novelty effect, the bottle may be advantageously used to keep separate those beverages or beverage components which may be degraded by mixing or whose colors may be muted or otherwise rendered less desirable by prior mixing.

In an alternative embodiment, a pair of dispensing tubes arranged in a spiral configuration is provided for simultaneously supplying the user with two different beverages contained in separate chambers within the bottle. In this embodiment, the beverages may be kept separate prior to entering the mouth cavity of the user.

### BRIEF DESCRIPTION OF THE DRAWING FIGURES

FIG. 1 is a front view of a drink bottle which embodies the present invention.

FIG. 2 is a top view thereof

FIG. 3 is a bottom view thereof.

FIG. 4 depicts the fluid flow during the dispensing operation.

FIG. 5 is an exploded view of a portion of the top section of the bottle.

FIG. 6 is an exploded view of the top portion of an alternative embodiment that includes a check valve.

FIG. 7 is a perspective view of an alternative embodiment having dispensing tubes in a spiral configuration.

FIG. 8 is an exploded view of the top portion of the embodiment shown in FIG. 7.

FIG. 9 depicts the fluid flow during the dispensing operation for the embodiment shown in FIG. 7.

FIG. 10 is a cross-sectional view taken along line 10-10 in FIG. 9.

FIG. 11 depicts another embodiment of the invention which includes a screw-on type cap.

FIG. 12A is an exploded view of the cap employed in the embodiment of FIG. 11.

FIG. 12B is a cross-sectional exploded view of the cap employed in the embodiment of FIG. 11.

FIG. 13 illustrates an embodiment of the invention which may include flexible bags for containing different beverages within the container.

FIG. 14A is an exploded view of a cap which may be used in the embodiment of FIG. 13.

FIG. 14B is a top view of the cap illustrated in FIG. 14A.

FIG. 14C is a top view of certain elements of the cap illustrated in FIG. 14A.

### DETAILED DESCRIPTION

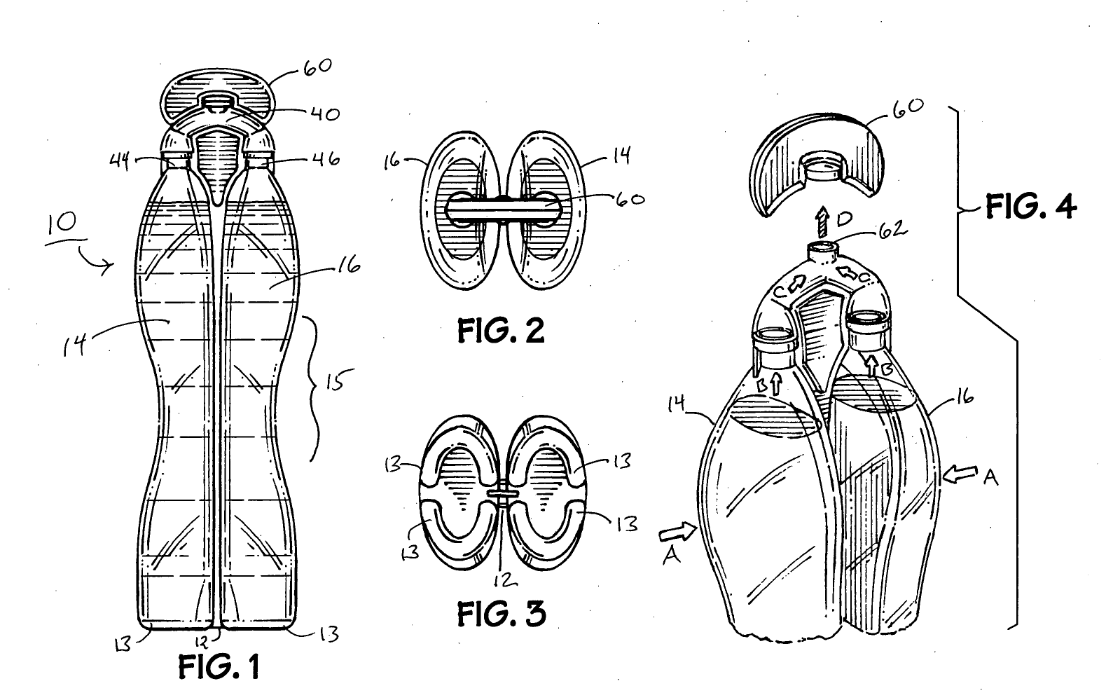

One particular embodiment of the present invention is illustrated in FIGS. 1 through 6. Bottle 10 may be formed of a thermoplastic resin by the blow molding technique. High density polyethylene (HDPE) and low density polyethylene (LDPE) are examples of suitable resins. As illustrated in the front view of FIG. 1, bottle 10 comprises two portions or compartments 14 and 16 which are joined together by partition 12. In the illustrated embodiment, bottle 10 features a contoured shape which includes portion 15 having a reduced diameter to facilitate grasping and squeezing the bottle by hand.

Bottle 10 may include snap-off type sealing top 60 and molded feet 13 for providing stability of the bottle when placed on a table top, counter or the like.

As may be seen in FIG. 1, compartments 14 and 16 are in fluid communication with mixing chamber 40 via passages 44 and 46, respectively. As illustrated in FIG. 4, when pressure is applied to the sides of bottle 10 in the direction indicated by arrows “A”, the fluids contained in compartments 14 and 16 are forced upward as indicated by arrows “B” through passages 44 and 46 and into mixing chamber 40. Mixing of the fluids may occur in mixing chamber 40 as the two fluids continue to flow through chamber 40 as indicated by arrows “C”. The mixed fluids from compartments 14 and 16 are expelled through orifice 62 as indicated by arrow “D”. In practice, orifice 62 would be placed in the mouth of the user who would squeeze the bottle to mix and inject the beverages or beverage components contained in compartments 14 and 16 into his or her mouth. It will be appreciated by those skilled in the art that the dispensing action is produced by differential pressure and the same effect may be obtained by applying suction—i.e., reduced pressure—to orifice 62.

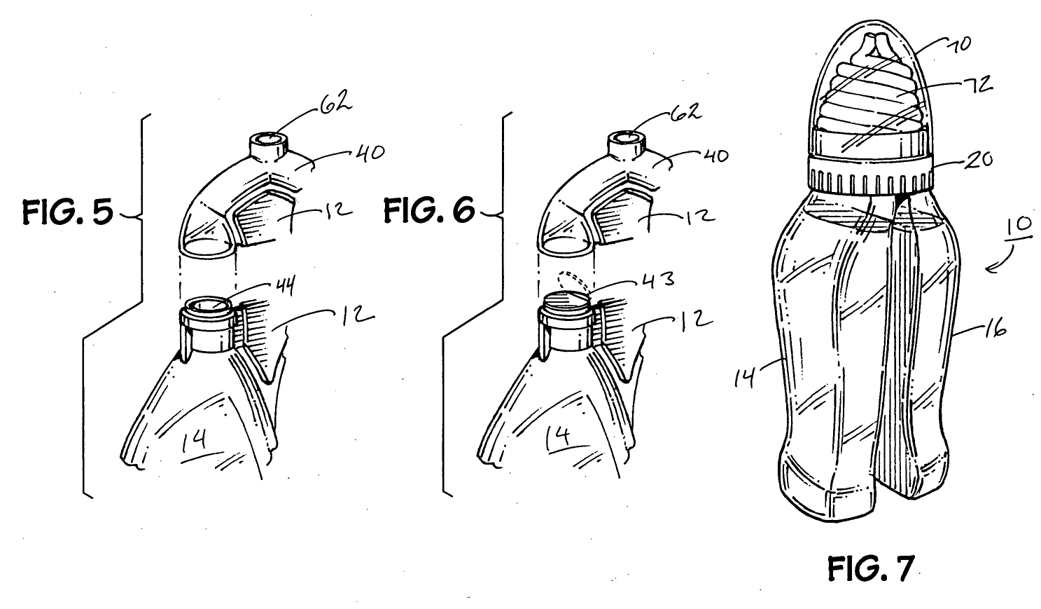

FIG. 5 is an exploded view of one side of the top portion of bottle 10. In the embodiment shown in FIG. 5, only the captive air (or other head gas) in mixing chamber 40 prevents the mixing of the contents of chambers 14 and 16 if bottle 10 is inverted or shaken (as, for example, during shipping and handling). Although this provision may be sufficient for most purposes, an alternative embodiment is shown in FIG. 6 which includes check valve 43 for preventing fluid flow from mixing chamber 40 back into compartment 14. Check valve 43 may comprise a simple flap-type arrangement which seals against the shoulder of orifice 44. In FIG. 6 the valve is shown in the closed position in solid lines and in the open position in dotted lines.

In use, valve 43 would be pushed to the position indicated by the dotted lines when positive pressure was applied to chamber 14 (thereby permitting fluid flow), but would be urged to the closed position (as shown by the solid lines) by any fluid flowing from chamber 40 towards compartment 14 such as, for example, when pressure on the bottle was relaxed or positive pressure was applied to orifice 62.

Another embodiment of the present invention is shown in the novelty drink bottle of FIG. 7. In this embodiment, each of compartments 14 and 16 are in fluid communication with a separate fluid delivery tube or “straw” 72 arranged in a spiral configuration. The intertwined fluid delivery tube structure may be protected by dust cap 70. For novelty effect, delivery tubes 72 and/or dust cap 70 may be fabricated from a clear material such as, for example, polycarbonate or polyethylene terephthalate (PET).

FIG. 8 is an exploded view of the top portion of the bottle illustrated in FIG. 7. In this particular embodiment, bottle 10 has an opening 80 with threaded portion 78 for engaging a screw-on type cap. Mouth 80 includes partition 82 which prevents fluid communication between chambers 14 and 16 within mouth 80. Cap 20 includes a spiral assembly 72 of two, fluid delivery tubes each of which is adapted to receive fluid from a single chamber within bottle 10. Cap 20 may include shoulder 84 for engaging dust cap 70 by means of a friction fit.

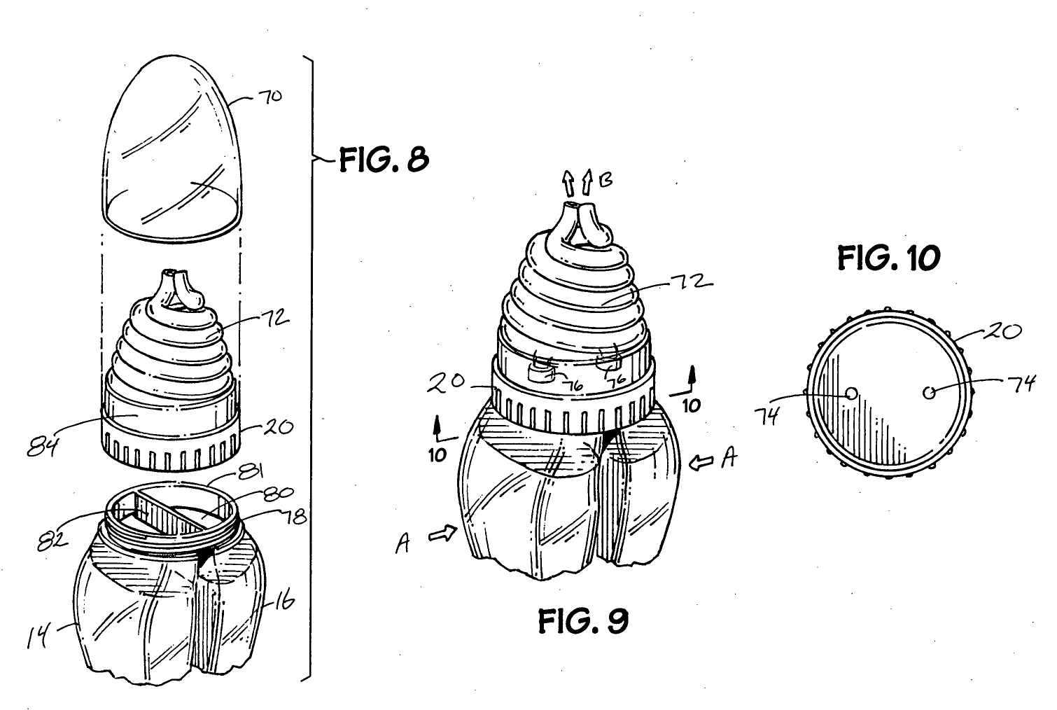

As shown in FIG. 9, pressure applied to the sides of bottle 10 by squeezing (as indicated by arrows “A”) forces fluid from each of the chambers comprising bottle 10 into the spiral assembly 72 of straws and causes the fluid to be expelled from the open ends of the tubes as shown by arrows “B”. Suction applied to the open ends of tubes 72 will, of course, produce the same result.

Also shown in FIG. 9 are receivers 76 which may be molded into cap 20 for receiving the inlet ends of tubes 72. As illustrated in FIG. 10, receivers 76 may be concentric with orifices 74 in cap 20 to provide fluid communication with compartments 14 and 16 when cap 20 is screwed onto bottle 10. A friction fit of the inlet ends of tubes 72 into receivers 76 provides one means of assembly and disassembly to permit cleaning and reuse of the bottle.

The top portion of partition 82 may be made coplanar with the top of mouth 80 such that when cap 20 is affixed to bottle 10, it provides a seal between compartments 14 and 16 when its interior surface contacts both the upper portion of annular wall 81 and partition 82 in sealing arrangement. Threaded portion 78 and the corresponding threads on cap 20 may be configured such that when cap 20 is fully screwed on to mouth 80 of bottle 10, orifices 74 are on opposite sides of partition 82.

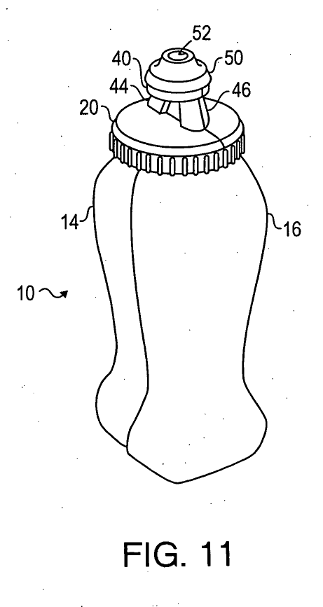

Referring now to FIG. 11, another embodiment of a beverage container 10 according to the present invention is illustrated in a perspective view. The particular embodiment illustrated may be disassembled for cleaning, refilling and reuse. The container 10 in the present embodiment is a bottle having separate bottle portions 14 and 16. The bottle portions 14 and 16 separately contain liquids that are not allowed to mix with the one other while in bottle. The liquids in the bottle portions 14 and 16 can be different flavors, for example, sour and sweet flavored beverages.

A cap 20 for mixing the separate liquids from the bottle portions 14 and 16 is attached to the bottle 10. The cap 20 includes a mixing chamber 40 and a tip 50. The mixing chamber 40 separately communicates with the bottle portions 14 and 16 so that the liquids from the bottle portions 14 and 16 can be separately mixed. The tip 50 may have hole 52 for drinking mixed liquids from the mixing chamber 40. Preferably, each bottle portion 14 and 16 is deformable. The bottle portions 14 and 16 in the present embodiment are preferably composed of thermoplastic material and are connected together by a central rib or common sidewall. Being deformable, the bottle portions 14 and 16 can be separately squeezed to force their flavored liquids into the mixing chamber 40. Thus, a user of the bottle 10 can dispense a desired mixture of the flavored liquids from the bottle portions 14 and 16 to the mixing chamber 40 for drinking. Having deformable bottle portions 14 and 16 offers one method for forcing the liquids from the bottle portion to the mixing chamber.

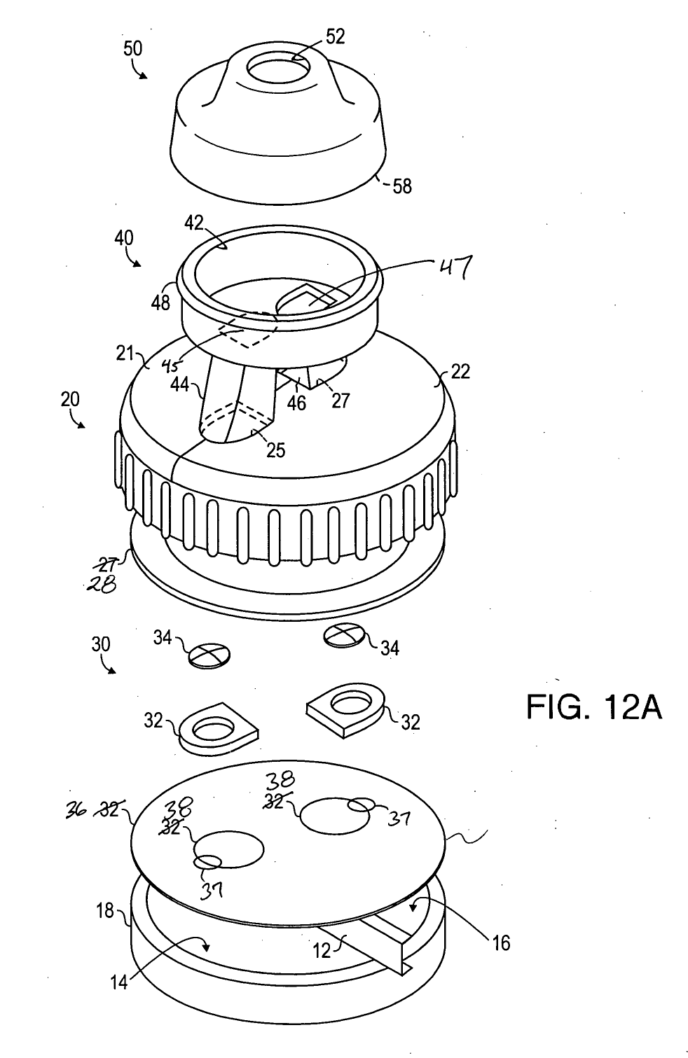

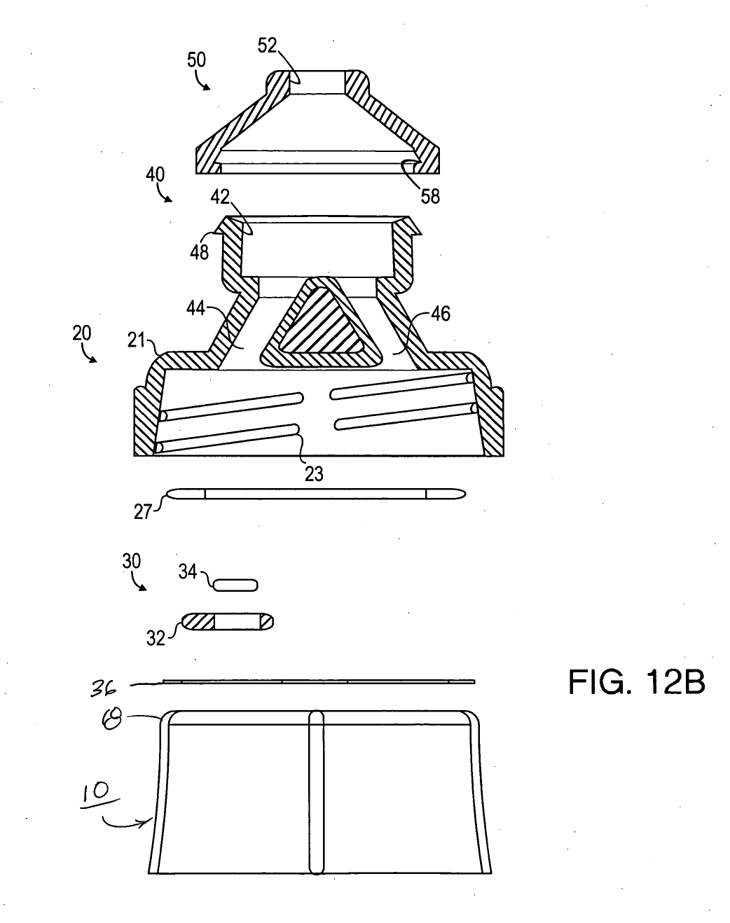

Referring to FIGS. 12A-B, the cap 20 of FIG. 11 is shown in exploded detail relative to an end 18 of the bottle portions 14 and 16. The cap 20 and end 18 are shown in perspective in FIG. 12A and in cross-section in FIG. 12B. The cap 20 may be removably attached to the bottle portions 14 and 16. In the present embodiment, the end 18 is threaded and is common to openings of both bottle portions 14 and 16. The cap 20 is formed from two molded halves 21 and 22 attached together. As best shown in FIG. 12B, the cap 20 has threads 23 for mating with the threaded end 18 of the bottle 10. A gasket 28 may be provided to ensure a liquid-tight seal between cap 20 and common threaded end 18 of the bottle 10. The common threaded end 18 of the bottle includes a dividing wall 12 that separates the two bottle portions 14 and 16 at the common end 18. A sealing liner 36 may be affixed to the common threaded end 18. Sealing liner 36 may provide a tamper-evident seal for bottle 10. Preferably, the sealing liner 36 is composed of plastic and is attached along its periphery to the upper lip of the common end 18. In addition, the sealing liner 36 is also preferably affixed to the upper edge of the dividing wall 12. The sealing liner 36 has first and second removable tabs 38 that separately allow liquids from the bottle portions 14 and 16 to pass when removed from the sealing liner 36. Accordingly, the sealing liner 36 with tabs 38 seals the two bottle portions 14 and 16 and prevents liquid from mixing between the bottle portions during transport and storage of the bottle 10. Once a user is prepared to drink from the bottle, the cap is removed from the common end of the bottle, the tabs are removed exposing holes to the separate bottle portions, and the cap is replaced on the common end of the bottle. Tabs 38 may be provided with lifting extensions 37 to facilitate their removal.

The mixing chamber 40 for mixing the liquids is attached to the cap 20. In the present embodiment, separate channels or tunnels 44 and 46 are formed between the cap 20 and the mixing chamber 40 and separately communicate the bottle portions 14 and 16 with the mixing chamber 40. The channels 44 and 46 respectively have openings 25 and 27 exposed to one of the bottle portions 14 or 16 and have another opening 45 or 47 exposed in the mixing chamber 40.

The channels 44 and 46 in the present embodiment offer one method for separately conveying the liquids contained in the bottle portions 14 and 16 to the mixing chamber 40. In an alternative embodiment, the mixing chamber 40 can be attached to or directly formed on the cap 20 without channels formed therebetween. Common openings in the mixing chamber and cap can therefore communicate the liquids from the bottle portions to the mixing chamber. Preferably, the mixing chamber and the channels are transparent to allow a user to view the separate liquids when dispensing them for drinking.

Valve assemblies 30 may be installed in the openings 25 and 27 of the cap 20 and may be used to prevent the liquids mixed in mixing chamber 40 from flowing back into bottle portions 14 and 16. Each valve assembly 30 separates one of the bottle portions 14 or 16 from the mixing chamber 40. The valve assemblies 30 each include a valve receiver 32 and a split diaphragm 34. The split diaphragms 34 are installed in the valve receivers 32, which are in turn installed in openings 25 and 27 in the cap 20. Each valve assembly 30 allows the liquid from a bottle portion to pass from the respective opening in the seal 36 to the mixing chamber 40. Each valve assembly preferably operates under a predetermined amount of pressure created by suction on the tip 50 or by squeezing the bottle portions.

Mixing chamber 40 in some embodiments may be at least partially transparent so as to enable a user to view the amount and mixture of liquid within the chamber. Channels 44 and 46 may also be transparent. In one embodiment of the disclosed beverage container 10, the mixing chamber 40 can define its own mouth or opening for drinking. In the present embodiment, however, the mixing chamber 40 has an open mouth 42 where the removable tip 50 attaches to cover the open mouth 42 and to enclose the chamber 40. The removable tip 50 defines an opening 52 for drinking liquids from the mixing chamber 40. To attach the tip 50 to the mixing chamber 40, the mixing chamber 40 has an annular flange 48 around the open mouth 42, and the tip 50 has a complimentary annular recess 58. In this arrangement, the tip 50 can snap onto the mixing chamber 40, but other arrangements are possible. With the tip 40 attached to the mixing chamber 40, a user can drink the mixed liquids in the chamber 40 from the opening 52 in the tip 50. Tip 50 may also be made transparent as well.

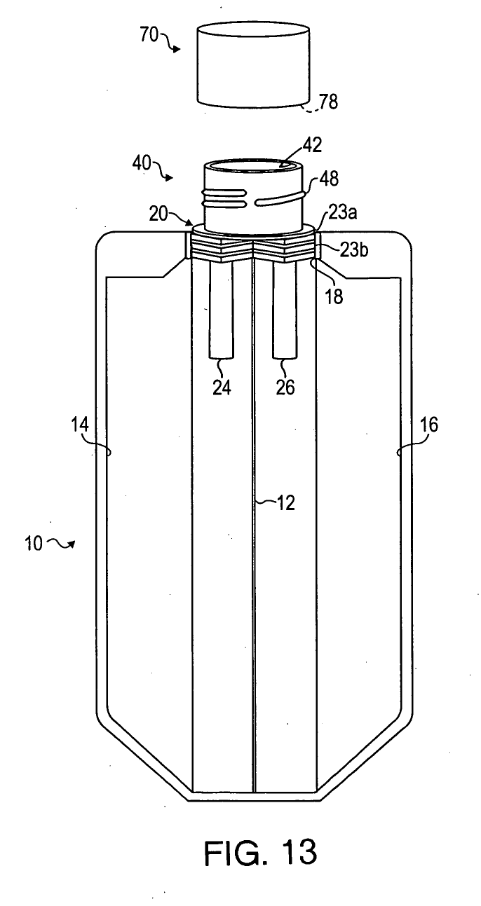

Referring to FIG. 13, another embodiment of a beverage container for dispensing a mixture of multiple liquids for drinking according to certain teachings of the present disclosure is illustrated in a partially exploded view. The container 10 in the present embodiment may be a bag or package having first and second pockets or compartments 14 and 16 separated by a division 12. One of ordinary skill in that art, however, will appreciate that the container can be separate bags or can be a box having divided compartments.

A cap 20 is attached a common open end 18 of the bag 10. In the present embodiment, the cap 20 is integrally molded to the bag 10. The cap 20 includes a shelf portion 23a and pressed molded portion 23b. The pressed molded portion 23b is formed by molded material being pressed during manufacture to attach to the common open end 18 of the bag 10. A mixing chamber 40 is attached to the cap 20. The mixing chamber has a open end 42 for drinking and has threads. A removable top 70 also has threads and removably attaches to the mixing chamber 40. Channels or tubes 24 and 26 are used to separately convey liquid from the compartments 14 and 16 to the mixing chamber 40 for drinking. One opening of the tubes is connected to the mixing chamber 40, and an another opening on the distal end of each tube is in fluid communication with the separate compartments of the bag.

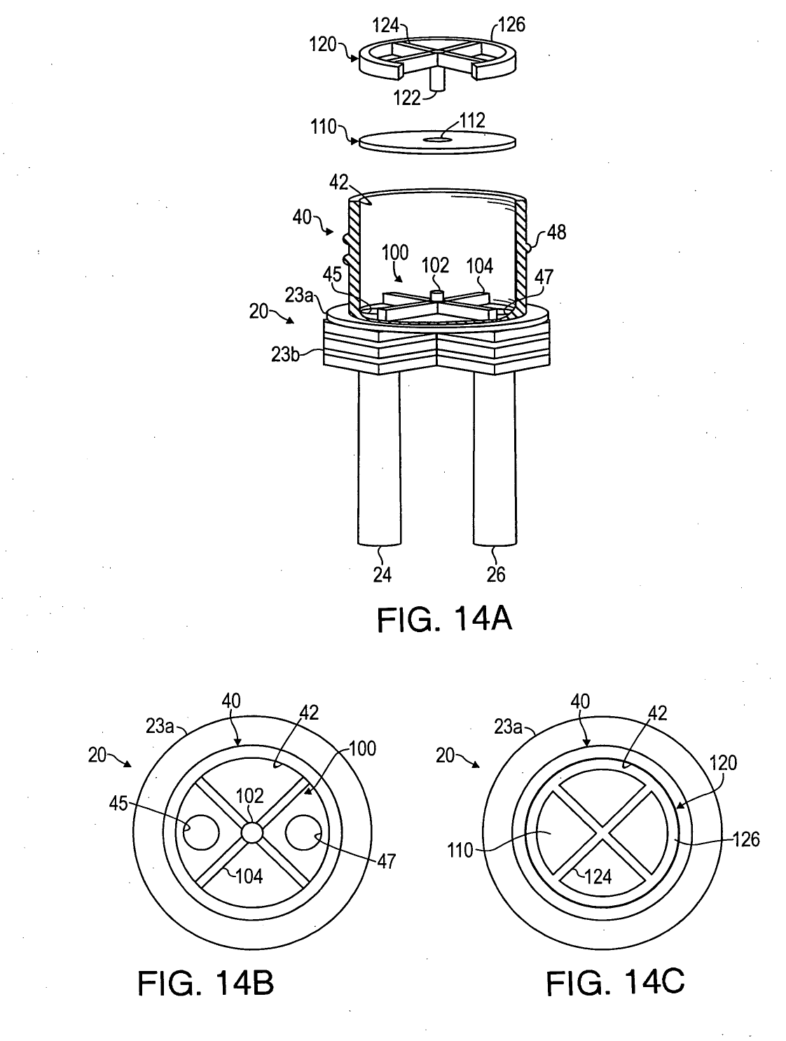

In the illustrated embodiment, valve assemblies, such as those disclosed above with reference to FIGS. 12A-B, can be installed in the tubes to separate the compartments from the mixing chamber 40. An alternative valve arrangement is illustrated in FIGS. 14A-C. FIG. 14A illustrates an exploded, partial cross-sectional view of the cap of the beverage bottle in FIG. 13 having the alternative valve arrangement. The alternative valve arrangement includes a lower support 100, a flexible diaphragm 110, and an upper support 120 installed in the mixing chamber 40. The lower support 100 is installed in the mixing chamber 40 adjacent the openings 45 and 47 for the tubes 24 and 26. The lower support has a center post 102 and a plurality of outwardly extending vanes 104. FIG. 14B illustrates a top view of the cap showing the lower support 100 with post and vanes installed in the bottom of the mixing chamber adjacent the openings 45 and 47. Lower support 100 may, in certain embodiments, be integrally formed with chamber 40.

As shown in FIG. 14A, flexible diaphragm 110 may have central opening 112. The diaphragm is preferably composed of silicone rubber or other like material. The diaphragm is installed in the chamber so that the opening fits onto post 102 of the lower support. The outside diameter of the diaphragm is approximately equal to that of the chamber so that the diaphragm substantially seals the upper and lower portions of the chamber when in an unflexed state.

The upper support 120 has a post 122, a plurality of outwardly extending vanes 124, and an annular wall 126. The upper support 120 positions and retains diaphragm 110 in the chamber, the post 122 attaches to the lower post 102. FIG. 14C illustrates a top view of the cap 20 showing the upper support 120 with vanes 124 installed in the mixing chamber above the diaphragm 110. The flexible diaphragm 110 is held between the upper and lower supports. As may be best seen in FIG. 14A, the post 122 on upper support 120 may install in a bore formed in the lower post 102. In addition, the diaphragm 110 is preferably held closer to the lower support. In this way, the periphery of the diaphragm can be flexed upwards by fluid pressure to allow liquid to pass from the exposed openings 45 and 47 of the tubes to the upper portion of the mixing chamber 40 for drinking.

As used in this description and in the appended claims, the word “container” does not necessarily refer to a rigid or a somewhat deformable structure, such as a “bottle,” “bottle portion,” or “bottle half” for containing liquid. Rather, as evidenced in the embodiment of FIG. 13, the word “container” in the present disclosure and in the appended claims can also mean a “box,” “packet,” “bag,” “portion of a bag,” “pocket of a bag,” or any such deformable structure for containing liquid.

As used in the present disclosure and in the appended claims, the word “channel” does not necessarily refer to a tunnel, straw, tube, bore, or other such elongated structure for conveying liquid. Rather, as evidenced in the embodiment of FIG. 1, the word “channel” in this description and in the appended claims can also refer to an “opening,” or any such structure for conveying liquid.

As used in the present disclosure and in the appended claims, the word “chamber” can refer to a cup having an open mouth for drinking or can refer to an enclosed compartment having an opening or orifice for drinking.

The foregoing description of preferred and other embodiments is not intended to limit or restrict the scope or applicability of the inventive concepts conceived of by the Applicant. In exchange for disclosing the inventive concepts contained herein, the Applicant desires all patent rights afforded by the appended claims. Therefore, it is intended that the invention include all modifications and alterations to the full extent that they come within the scope of the following claims or the equivalents thereof.

What is claimed is:

1. A container for liquids, comprising:
a plurality of container portions separately containing the liquids; and
a mixing chamber for drinking attached to the container and separately communicating with each of the plurality of container portions.

2. The container of claim 1, wherein each of the plurality of container portions is deformable for forcing the contained liquid to the mixing chamber.

3. The container of claim 1, wherein the plurality of container portions are separate sections of a bottle.

4. The container of claim 1, wherein the plurality of container portions are separate pockets of a bag.

5. The container of claim 1, wherein the mixing chamber is integrally or removably attached to the container portions.

6. The container of claim 1, wherein the mixing chamber comprises a cap portion threading on a common end of the container portions.

7. The container of claim 1, wherein the mixing chamber defines a plurality of openings for separately communicating with each of the plurality of container portions.

8. The container of claim 1, wherein the mixing chamber comprises a plurality of channels for separately communicating with the plurality of container portions.

9. The container of claim 8, wherein each channel comprises a tube attached to the cap portion and having a distal end disposed in one of the plurality of container portions.

10. The container of claim 8, wherein each channel comprises a tunnel integrally formed between the mixing chamber and the cap portion, the tunnel having one opening exposed in the mixing chamber and another end exposed in one of the plurality of container portions.

11. The container of claim 1, wherein the mixing chamber comprises a removable tip having an opening for drinking liquids from the mixing chamber.

12. The container of claim 11, wherein the removable tip is integrally attached to the mixing chamber such that an opening is formed in the mixing chamber for drinking the liquids when the removable tip is removed.

13. The container of claim 1, further comprising a plurality of valves, each valve separating one of the plurality of container portions from the mixing chamber.

14. The container of claim 13, wherein the valves each comprises a split diaphragm positioned within an opening communicating one of the plurality of container portions with the mixing chamber.

15. The container of claim 1, further comprising at least one valve separating each of the plurality of container portions from the mixing chamber.

16. The container of claim 15, wherein the at least one valve comprises at least one diaphragm positioned within the mixing chamber.

17. The container of claim 16, wherein an upper support and a lower support in the mixing chamber hold the at least one diaphragm therebetween.

18. The container of claim 17, wherein the upper and lower supports each comprise a plurality of outwardly extending vanes.

19. A container for mixing and dispensing liquids for drinking, comprising:
a plurality of container portions separately containing liquids; and
a cap portion attached to the container portions and having a plurality of channels separately communicating with the container portions for drinking.

20. The container of claim 19, wherein each container portion is deformable for forcing its separately contained liquid through its channel to the mixing chamber.

21. The container of claim 19, wherein the container portions are separated pockets of a bag.

22. The container of claim 19, wherein the cap portion is integrally or removably attached to the container portions.

23. The container of claim 19, wherein the cap portion comprises threads threading on an open end of the container portions.

24. The container of claim 19, wherein the plurality of channels define straws, each straw attached to an opening in the cap portion.

25. The container of claim 19, further comprising a plurality of valves, each valve separating one of the container portions from one of the channels.

26. The container of claim 25, wherein the valves each comprises a split diaphragm positioned within an opening in the cap portion communicating one of the container portions with one of the channels.

27. A container for liquids, comprising:
means for separately containing the liquids;
means for separately measuring the contained liquids; and
means for mixing the measured liquids; and
means for drinking the mixed liquids.

28. The container of claim 27, wherein the means for separately measuring the contained liquids comprises means for forcing the liquids into the means for mixing the measured liquids.

29. The container of claim 27, wherein the means for drinking the mixed liquids comprises means for forming a drinking opening when a portion of the container is removed.

30. The container of claim 27, wherein the means for separately measuring the contained liquids comprises means for passing the liquid under a predetermined amount of pressure.
